(19) United States
(12) Patent Application Publication
(10) Pub. No.: US 2025/0327419 A1
(43) Pub. Date: Oct. 23, 2025

(54) Gas Turbine System

(71) Applicant: Renato Martinez Openiano, Chula Vista, CA (US)

(72) Inventor: Renato Martinez Openiano, Chula Vista, CA (US)

(21) Appl. No.: 19/183,870

(22) Filed: Apr. 20, 2025

Related U.S. Application Data
(60) Provisional application No. 63/731,334, filed on Apr. 20, 2024.
(60) Provisional application No. 63/731,340, filed on Apr. 22, 2024.
(60) Provisional application No. 63/731,385, filed on Apr. 25, 2024.
(60) Provisional application No. 63/731,434, filed on May 2, 2024.
(60) Provisional application No. 63/732,037, filed on Jul. 8, 2024.
(60) Provisional application No. 63/732,390, filed on Aug. 9, 2024.
(60) Provisional application No. 63/732,567, filed on Aug. 28, 2024.

(51) Int. Cl. F02C 6/16

(52) U.S. Cl. CPC F02C 5/12; F02C 3/14; F02C 3/30; F02C 3/32; F02C 3/34; F02C 6/14; F02C 6/16; F02C 9/16; F23R 2900/03341

(57) ABSTRACT

A gas turbine system, comprising a combustor apparatus, which includes at least one combustion chamber configured to: receive compressed gas and a combustion fuel, generate combustion of the compressed gas thereby generating combusted gas; and to release the combusted gas toward a turbine for rotating the turbine. The at least one combustion chamber is configured to have a plurality of discrete sequential combustion cycles, each combustion cycle having an initial time interval in which the compressed gas and the combustion fuel are received, and a final time interval in which the combustion is performed and the combusted gas is released toward the turbine, the initial and final time interval being sequential to one another.

### CROSS-REFERENCES TO RELATED APPLICATIONS

This application claims priority from U.S. Provisional Application Ser. No. 63/731,334 filed on Apr. 20, 2024, U.S. Provisional Application Ser. No. 63/731,340 filed on Apr. 22, 2024, U.S. Provisional Application Ser. No. 63/731,385 filed on Apr. 25, 2024, U.S. Provisional Application Ser. No. 63/731,434 filed on May 2, 2024, U.S. Provisional Application Ser. No. 63/732,039 filed on Jul. 5, 2024, U.S. Provisional Application Ser. No. 63/732,390 filed on Aug. 9, 2024, and U.S. Provisional Application Ser. No. 63/732,567 filed on Aug. 28, 2024, all of which are incorporated herein by reference in their respective entirety.

### TECHNICAL FIELD

The present invention relates to gas turbines, and more particularly, but not exclusively, to gas turbines for the production of electricity.

### BACKGROUND

Power plants based on gas turbines produce combustion of a gas with a fuel, which generates a combusted gas at high pressure and high temperature. The combusted gas is used to rotate a turbine connected to a shaft. The rotation of the shaft is converted to electricity. In many power plants, the combustion fuel is natural gas.

Natural gas turbines electrical generation reached a global capacity of 2.02 terawatts, producing 6,635 terawatt hours in 2023, and this natural gas power generation capacity projected to increase by an additional 688 gigawatts in 2024 and projected to increase by 4% yearly until 2030.

The combustion of gas (generally air) with natural gas produces high levels of nitrogen oxides (NOx), CO₂ and CO. The higher the temperature of the combusted gases, the higher the production of NOx. Moreover, the less efficient the gas turbine is, the more fuel is used, leading to higher production of CO₂. Finally, incomplete combustion leads to production of CO.

Since high-pressure combusted gas is desirable to provide higher motive force to the turbine, combustion temperatures of gas turbines known in the art are generally above 1300° C., with some gas turbines having combustion temperatures above 1600° C., to generate the desired pressure. At these temperatures, nitrogen and oxygen atoms combine and produce NOx. Advanced gas turbine power plants fueled by natural gas generally produce 15 ppm of NOx, which are above the 10 ppm NOx production level set by European Union countries.

Moreover, in the general art, the turbine blades need to be resistant to high temperatures, since the turbines are struck by high temperature gases produced during combustion. This increases the cost of the turbine blades and may cause structural failure of the blades, which requires replacement of these blades.

### BRIEF SUMMARY OF EMBODIMENTS OF THE INVENTION

Many countries have set a timeline for net zero emissions by 2050 or sooner. Therefore, there is a need to reduce emissions of NOx, CO₂, and CO in gas turbine power plants.

The present invention aims at providing a gas turbine power plant with increased fuel efficiency, which produces combusted gas at a lower temperature and lower pressure than conventional gas turbine power plants. This decreases NOx and CO₂ emissions, allows for lower-cost turbine blades, and can decrease the frequency of structural failure of the turbine blade.

Another aim of the present invention is to increase the completeness of the combustion, therefore reducing CO emissions.

Yet another aim of the present invention is to provide a gas turbine power plant that can use hydrogen as a fuel, instead of a fossil fuel.

Therefore, an aspect of some embodiments of the present invention relates to a gas turbine system, comprising a combustor apparatus and a pressure tank. The combustor apparatus includes at least one combustion chamber configured to receive compressed gas and a combustion fuel, configured to generate combustion of the compressed gas thereby generating combusted gas, and configured to release the combusted gas. The pressure tank, is configured to receive the combusted gas released from the at least one combustion chamber, store the combusted gas at a desired pressure, and controllably deliver the combusted gas to one or more turbines via one or more first outlets, for rotating the one or more turbines.

In a variant, the combustor apparatus comprises a plurality of combustion chambers, each of the combustion chambers being configured to receive the compressed gas and the combustion fuel separately from other combustion chambers, to generate a respective combustion of the compressed gas, and to release the combusted gas to the pressure tank.

In another variant, the combustion chambers are configured to receive the gas and the fuel at successive time intervals such that the combustion occurs sequentially in at least some of the combustion chambers, and to sequentially release the combusted gas.

In yet another variant, the gas turbine system includes a plurality of ignitor units, wherein: each of the combustion chambers comprises a respective one of the ignitor units; at least some of the ignitor units are controlled to sequentially ignite respective sparks, to cause the combustion to occur sequentially in the at least some of the combustion chambers.

In a further variant, the at least one combustor chamber comprises an intake port and a first discharge port. The intake port is configured to be controlled to open for receiving the gas and the fuel during a first time interval and close at the end of the first time interval. The first discharge port is configured to open at a time after the first time interval, when a pressure inside the combustion chamber builds up to a predetermined pressure as a result of the combustion and to close when the pressure inside the combustion chamber falls below the predetermined pressure, wherein the first discharge port is in communication with the pressure tank and is configured to discharge the combusted gas to the pressure tank, when open.

In a further variant, for the at least one combustor chamber, a combustion cycle occurs during a cycle period divided into a first time interval, a second time interval, and a third time interval, and wherein the at least one combustion chamber comprises an intake port a first discharge port, and a second discharge port. The intake port is configured to be controlled to open for receiving the gas and the fuel during at the beginning of the first time interval and to close at the end of the first time interval. The first discharge port is configured to open during the second time interval when a pressure inside the combustion chamber builds up to a predetermined pressure as a result of the combustion, to discharge the combusted gas, and to close when the pressure inside the combustion chamber falls below the predetermined pressure, wherein the first discharge port is in communication with the pressure tank and is configured to discharge the combusted gas to the pressure tank, when open. The second discharge port configured to be controlled to open at the beginning of the third time interval, to discharge combustion remnants, and to close at the end of the third time interval.

In yet a further variant, the gas turbine system further comprises a compressor for compressing gas and deliver the compressed gas to the at least one combustion chamber. The second discharge port is in communication with an inlet of the compressor and is configured to deliver the combustion remnants to the compressor for compression and delivery to the combustor apparatus.

In a variant, the gas turbine system further comprises a compressor for compressing gas and deliver the compressed gas to the at least one combustion chamber. The compressor comprises a second turbine configured to power the compressor. The pressure tank has at least one second outlet configured to deliver some of the combusted gas to the second turbine for rotating the second turbine.

In another variant, the gas turbine system comprises at least one eductor comprising a gas entry opening and an exit opening. The gas entry opening is in communication with one of the one or more first outlets of the pressure tank and configured to receive the combusted gas therefrom. The exit opening is directed toward blades of the one of more turbines, to release the combusted gas to the at least one turbine and cause the at least one turbine to rotate.

In yet another variant, the he at least one eductor comprises a liquid entry opening configured to receive liquid, such that a mixture of the compressed gas and the liquid is released from the exit opening to the at least one turbine.

In a further variant, the gas turbine system comprises a plurality of eductors having respective exit openings directed at respective locations of the at least one turbine.

In yet a further variant, the gas turbine system comprises a delivery tank configured to receive the compressed gas, the delivery tank having a plurality of egress channels, each of the egress channels configured to deliver the compressed gas to a respective one of the plurality of combustion chambers.

Another aspect of some embodiments of the present invention relates to a gas turbine system, comprising: a source of pressurized gas, and at least one eductor comprising a gas entry opening and an exit opening. The gas entry opening is configured to receive the pressurized gas. The exit opening is directed toward a turbine, to release the pressurized gas to the turbine in order to cause the turbine to rotate.

In a variant, the at least one eductor comprises a liquid entry opening configured to receive a liquid, such that a mixture of the pressurized gas and the liquid is released from the exit opening to the turbine.

In another variant, the gas turbine system comprises a plurality of eductors having respective exit openings directed at respective locations of the turbine.

In yet another variant, the gas turbine system comprises at least one vertical turbine having at least one Pelton blade, wherein the at least one eductor is configured to release the pressurized gas to the turbine substantially horizontally to impact the at least one Pelton blade, in order to cause the turbine to rotate along a vertical axis.

A further aspect of some embodiments of the present invention A gas turbine system, comprising a plurality of vertical turbines disposed vertically and joined to a common central rod, and a plurality of sets of eductors, each set of eductors comprising one or more eductors aimed at a respective one of the vertical turbines. Each of the eductors comprises a gas entry opening and an exit opening. The gas entry opening is configured to receive pressurized gas from a pressurized gas source. The exit opening is directed toward the respective one of the turbines, to release the pressurized gas to turbine in order to cause the respective one of the turbines to rotate.

In a variant, at least one of the eductors comprises a liquid entry opening configured to receive a liquid, such that a mixture of the compressed gas and the liquid is released from the exit opening to the respective one of the turbines.

In another variant, the gas turbine system comprises at least one liquid jet nozzle located near at least one of the eductors and configured to emit a liquid jet to the respective turbine.

In yet another variant, the gas turbine system includes a sump and a liquid line. The sump is located under a lowermost of the vertical turbine, and is configured to collect the liquid released from the exit opening of the at least one of the eductors which comprises the liquid entry opening. The liquid line redirects at least some of the liquid from the sump back into liquid entry opening of the at least one of the eductors.

In a further variant, the system comprises a gutter structure comprises a plurality of receptacles and a spout. Each receptacle is located under a respective one of the turbines and configured to collect the liquid that was released toward the respective one of the turbines after the liquid has interacted with the respective one of the turbines. The spout is in communication with the receptacles, and configured to receive the liquid from the receptacle and to lead the liquid to a sump.

In yet another, the turbines are configured to turn along a vertical axis when the pressurized gas travels downwards through the turbines. Each set of eductors is coupled to a respective one of the turbines, comprises a plurality of eductors located above the respective one of the turbines, and is configured to eject the pressurized gas substantially vertically. The eductors of at least two consecutive sets associated with the two consecutive turbines of the plurality of the turbines are disposed in a staggered manner, such that the eductors of one of the two consecutive sets are not vertically aligned with the eductors of another one of the two consecutive sets.

In yet a further variant, the turbines are configured to turn along a vertical axis when the pressurized gas travels downwards through the turbines. Each set of eductors is coupled to a respective one of the turbines, comprises a plurality of eductors located above the respective one of the turbines, and is configured to eject the pressurized gas substantially vertically. The system comprises a ducting structure between two consecutive turbines of the plurality of turbines, the ducting structure having openings aligned with locations of a lower one of the two consecutive turbines that are not impacted by pressurized gas from eductors of a set associated with the lower one of the two consecutive turbines.

Another aspect of some embodiments of the present invention relates to a gas turbine system, comprising a combustor apparatus, which includes at least one combustion chamber configured to: receive compressed gas and a combustion fuel; generate combustion of the compressed gas thereby generating combusted gas; and release the combusted gas toward a turbine for rotating the turbine. The at least one combustion chamber is configured to have a plurality of discrete sequential combustion cycles, each combustion cycle having an initial time interval in which the compressed gas and the combustion fuel are received, and a final time interval in which the combustion is performed and the combusted gas is released toward the turbine, the initial and final time interval being sequential to one another.

In a variant, the gas turbine system further comprises a control unit configured to control a timing sequence of operations of the at least one combustion chamber.

In another variant, the combustor apparatus comprises a plurality of combustion chambers, each of the combustion chambers being configured to receive the compressed gas and the combustion fuel separately, to generate a respective combustion of the compressed gas, and to separately release the combusted gas to the pressure tank.

In yet another variant, the combustion chambers are configured to receive the gas and the fuel at successive time intervals such that the combustion occurs sequentially in at least some of the combustion chambers, and to sequentially release the combusted gas.

In a further variant, the gas turbine system comprises a plurality of ignitor units and a control unit configured to control a timing sequence of operations of the at least one combustion chamber. Each of the combustion chambers comprises a respective one of the ignitor units. The control unit is configured to control at least some of the ignitor units to sequentially ignite respective sparks, to cause the combustions to occur sequentially in the at least some of the combustion chambers.

In yet a further variant, the at least one combustor chamber comprises an intake port and a first discharge port. The intake port is configured to be controlled to open for receiving the gas and the fuel during the initial time interval and close at the end of the initial time interval. The first discharge port is configured to open at a time in the final time interval, when a pressure inside the combustion chamber builds up to a predetermined pressure as a result of the combustion and to close when the pressure inside the combustion chamber falls below the predetermined pressure, wherein the first discharge port is is configured to discharge the combusted gas out go the at least one combustor chamber, when open.

In a variant, for the at least one combustor chamber, a combustion cycle occurs during a cycle period divided into a first time interval, a second time interval, and a third time interval, wherein the first time interval corresponds to the initial time interval, while the final time interval comprises the second time interval and the third time interval, and wherein the at least one combustion chamber comprises an intake port, a first discharge port, and a second discharge port. The intake port is configured to be controlled to open for receiving the gas and the fuel during at the beginning of the first time interval and to close at the end of the first time interval. The first discharge port is configured to open during the second time interval when a pressure inside the combustion chamber builds up to a predetermined pressure as a result of the combustion, to discharge the combusted gas, and to close when the pressure inside the combustion chamber falls below the predetermined pressure, wherein the first discharge port is configured to discharge the combusted gas out go the at least one combustor chamber, when open. The second discharge port configured to be controlled to open at the beginning of the third time interval, to discharge combustion remnants, and to close at the end of the third time interval.

In yet another variant, the gas turbine system comprises a compressor configured to provide the compressed gas to the combustion apparatus, wherein the compressor is not physically integral with the combustion apparatus.

In a further variant, the gas turbine system comprises the turbine, wherein the combustor apparatus and the turbine are not physically integral with each other.

In yet a further variant, the control unit is configured as a computerized unit having a processing utility, and a storage utility. The storage utility is configured to store machine readable instructions configured to cause the processing utility to generate control signals configured to be received by the combustor apparatus to control an operation of the control apparatus.

### BRIEF DESCRIPTION OF DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates a gas turbine system which includes at least one combustion chamber, according to some embodiments of the present invention;

FIG. 2 illustrates an example of a combustion chamber, according to some embodiments of the present invention;

FIG. 3 illustrates a gas turbine system which includes a pressure tank for receiving combusted gas and delivering the combusted gas to a turbine, according to some embodiments of the present invention;

FIG. 4 illustrates a gas turbine including one or more turbines receiving pressurized gas via eductors, according to some embodiments of the present invention;

FIGS. 5-7 are top views of a top, middle, and low turbine, respectively, showing examples of locations of eductors above the respective turbines, according to some embodiments of the present invention;

FIGS. 8 and 9 respectively illustrate examples of a first eductor and a second eductor, according to some embodiments of the present invention;

FIG. 10 illustrates an example of a gas turbine system in which a liquid is directed toward turbines together with the combusted gas, according to some embodiments of the present invention;

FIG. 11 illustrates a multi-turbine system in which a plurality of turbines are located above each other, and pressurized gas is directed from upper turbines to lower turbines via a ducting structure, according to some embodiments of the present invention;

FIG. 12 illustrates a top view of the ducting structure, according to some embodiments, of the present invention;

FIG. 13 illustrates a top view of the ducting structure above the middle turbine, according to some embodiments, of the present invention;

FIG. 14 illustrates a top view of a second ducting structure below the middle turbine, according to some embodiments, of the present invention;

FIG. 15 illustrates a top view of the second ducting structure above the bottom turbine, according to some embodiments, of the present invention;

FIGS. 16-18 illustrate a turbine with extended turbine blades for receiving air from two groups of eductors forming an inner group and an outer group;

FIGS. 19 and 20 illustrate a turbine which include a gutter structure, according to some embodiments, of the present invention;

FIGS. 21 and 22 illustrate a turbine with Pelton blades, according to some embodiments, of the present invention;

FIG. 23 is a flowchart which illustrates a combustion cycle, according to some embodiments of the present invention;

FIGS. 24 and 25 are charts illustrating the opening and closing of the ports of the combustion chambers during 18-second combustion cycles, according to some embodiments of the present invention; and

FIG. 26 is a block diagram illustrating a control unit, according to some embodiments of the present invention.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

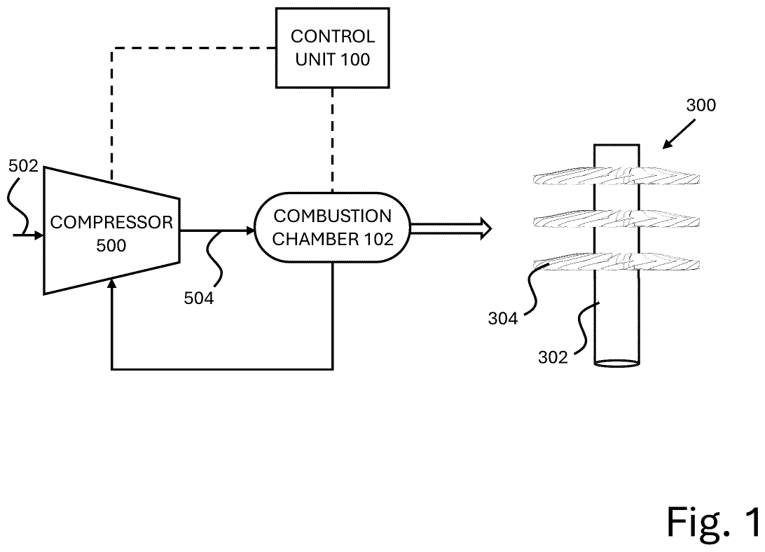

Referring now to the drawings, FIG. 1 illustrates a gas turbine system which includes a combustion chamber configured to perform separate and sequential cycles of combustion, according to some embodiments of the present invention.

The system of FIG. 1 includes at least one combustion chamber 102 and a control unit 100. The combustion chamber 102 is configured to receive a compressed gas and a fuel, to cause the gas to combust with the fuel combust to generate combusted gas, and eject the combusted gas toward a turbine apparatus 300, to provide motive force that causes the turbine(s) 304 of the turbine apparatus 300 to rotate, thereby rotating a rod 302. The rotation of the rod can be converted to electricity, as known in the art. The turbine(s) 304 may be vertical or horizontal turbines. The combusted gas may be led to the turbine(s) in order to impact the turbine(s) at an advantageous angle for efficiently turning the turbine(s).

Once the combusted gas is ejected out of the combustion chamber 102 via a discharge port, an intake port of the combustion chamber is reopened to receive a new batch of gas and fuel to ignite for the next cycle.

The control unit 100 is configured to control the operation of the combustion chamber 102, by controlling the timings of the opening of the intake port for the injection of the air and fuel into the combustion chamber, of the ejection of the combusted gas out of the combustion chamber, and of the ignition of the gas and fuel inside the combustion chamber to start combustion.

In this manner, the combustion chamber 102 performs separate, sequential cycles of combustion, rather than continuous combustion. Each cycle completes before the next cycle starts. Each cycle has an initial time interval and a final time interval. In the initial time interval, the compressed gas and fuel are injected into the combustion chamber. No combusted gas is ejected out of the combustion chamber in the initial time interval. In the final time interval (which does not overlap with the initial time interval), no intake of compressed gas and fuel occurs, and the ignition occurs (which causes the combustion) and the combusted gas is released toward the turbine. This is a departure from known gas turbines, in which the combustion is continuous, and intake of air and fuel and release of combusted gas occur simultaneously and continuously. An advantage of having discrete combustion cycles in a combustion chamber (as opposed to continuous combustion as known in the prior art) lies in the capability of the system of the present invention to control the timings of the cycles. In this manner, a more complete combustion is performed in each cycle before the next cycle starts, thereby reducing the emission of CO gas.

In some embodiments of the present invention, the compressed gas is provided via a compressor 500, which has an inlet 502 and an outlet 504. The compressor 500 receives gas (e.g., ambient air) and compresses the gas. The compressed gas exits the compressor 500 via the outlet 504 and is delivered, along with fuel, to the combustion chamber 102, for the combustion to occur. The operation of the compressor may be controlled by the control unit 100. In some embodiments of the present invention, the compressor, combustion apparatus, and turbine that are configured as discrete components that not integral with each other. This is a departure from the general art, in which these components are part of an integrated system.

In some embodiments of the present invention, after the combusted gas exits the combustion chamber, combustion remnants (that may include some fuel and some uncombusted or partially combusted gas) are led from the combustion chamber 102 back to the compressor 500, from the compressor 500 and back into the combustion chamber(s) in order to complete the combustion. This enhances the completeness of combustion, as at least some partially combusted gas (which includes CO) is not directed to the turbine and then emitted into the air. Rather, some of the partially combusted gas is recycled and fed back into the compressor for reintroduction into the combustion chamber, where the partially combusted gas undergoes another combustion cycle and becomes completely combusted. This further decreases the emission of CO into the atmosphere.

Moreover, the recycling of combustion remnants may also decrease the power needed by the compressor 500 to compress gas to a desired pressure for injection into the combustion chamber 102. In fact, the combustion remnants inside the combustion chamber may be at a higher pressure than gas entering the compressor 500 from the inlet 502. Therefore, by recycling combustion remnants the compressor has to perform less work to drive gas into the combustion chamber at a desired pressure than would be required to pressurize ambient air alone (having lower pressure than the combustion remnants) for introduction into the combustion chamber.

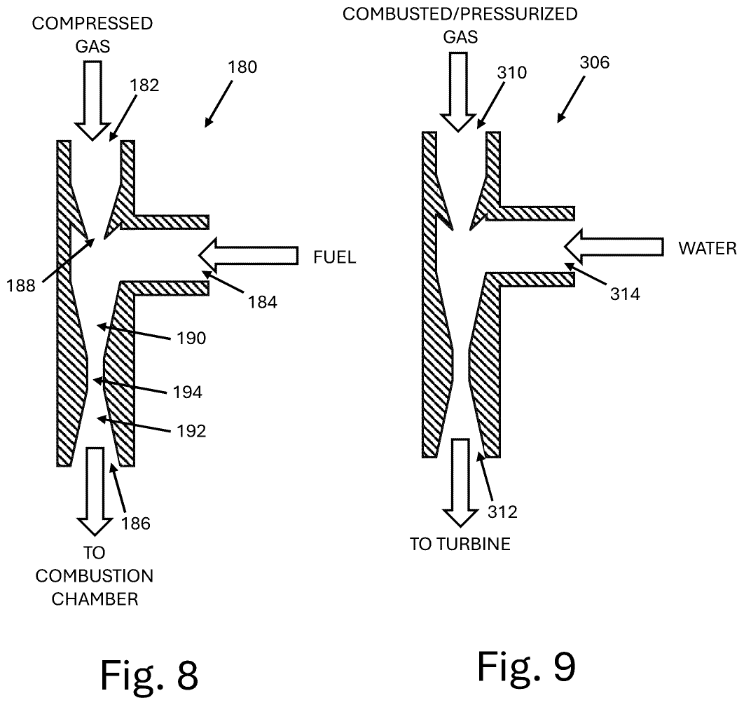

In some embodiments of the present invention, the compressed gas is delivered to the combustion chamber via a first eductor 180, as seen in FIG. 8. The first eductor 180 includes a gas entry opening 182, a fuel entry opening 184, and an exit opening 186. Compressed gas from the compressor 500 enters through the gas entry opening. The fuel (e.g., natural gas, gasoline, or hydrogen) from a fuel reservoir enters from the fuel entry opening 184. The fuel and compressed air leave the first eductor via the exit opening 186 and enter the combustion chamber. In some embodiments of the present invention, a straight path is present between the gas entry opening 182 and the exit opening 186, while the path from the fuel entry opening to the exit opening 186 is not straight. The fuel enters the first eductor 180 at an angle (e.g. a 90-degree angle) with the path of the compressed gas. The compressed gas is the motive fluid, and the movement of the compressed gas from the gas entry opening 182 to the exit opening 186 creates a low-pressure region at the fuel entry opening 184, to create a suction effect at the fuel entry opening 184 to suck in the fuel and lead the fuel to the exit opening with the compressed gas.

In some embodiments of the present invention a first inner nozzle 188 is present to further compress the compressed gas and release the compressed gas at the meeting point with the fuel's path. In some embodiments of the present invention, the paths of the compressed gas and of the fuel join and include a converging nozzle 190 and a diverging diffuser 192 (the diffuser 192 being downstream of the converging nozzle), before exiting the first eductor via the exit opening 186. In some embodiments of the present invention, a diffuser throat 194 having a constant cross section is located between the converging nozzle 190 and the diverging diffuser 192. It should be noted that this structure is provided only as a non-limiting example. Other structures of eductors may be used according the system's requirements, and are within the scope of this patent application.

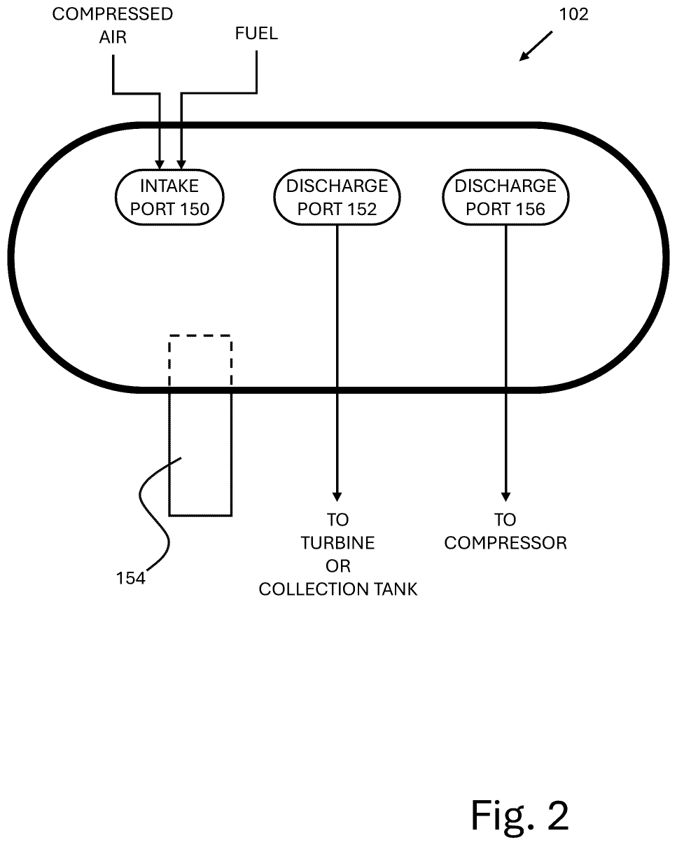

FIG. 2 illustrates an example of a combustion chamber 102, according to some embodiments of the present invention.

The combustion chamber 102 includes an intake port 150, and a first discharge port 152. Compressed gas and fuel enter the intake port 150. In some embodiments of the present invention, combustion of the gas occurs when pressure inside the combustion chamber 102 reaches a certain level. In some embodiments of the present invention combustion of the gas occurs when an ignitor unit 154 (such as a spark plug, for example) is activated to ignite a spark within the compression chamber 102. The pressure of the compressed gas and fuel required in the combustion chamber for combustion to start is lower when an ignitor unit is used.

Once combustion starts, the pressure within the combustion chamber quickly rises and the first discharge port 152 opens to eject the combusted gas toward the turbine or to the collection tank. The opening of the first discharge port 152 may be controlled by the control unit. For example, the control unit may open the first discharge port 152 at predetermined time intervals. In another variant, the first discharge port 152 is configured to open in response to a pressure difference between the inside of the combustion chamber and the inside of the collection tank (if present), or the environment around the turbine (if the collection tank is not present, and the combusted gas is delivered directly to the turbine). For example, the first discharge ports 152 may be connected to a spring one-way check valve, which is pushed by internal pressure to open when the pressure difference mentioned above is above a predetermined threshold.

In some embodiments of the present invention, the combustion chamber 102 includes a second discharge port 156. The second discharge port is controllably opened (for example, via the control unit) to eject the combustion remnants. The combustion remnants may be led back to the compressor's inlet to be fed again as compressed gas, to enhance the completeness of the combustion, as discussed above.

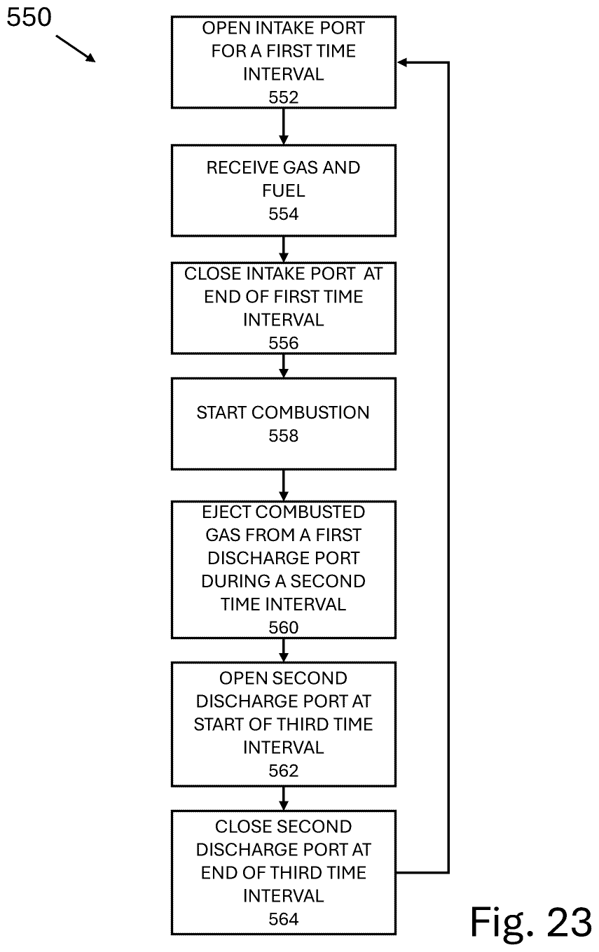

Referring now to FIG. 23 in combination with FIG. 2, in some embodiments of the present invention, the combustion cycle in a combustion chamber occurs during a cycle period divided into a first time interval, a second time interval, and a third time interval, as seen in flowchart 550. The end of the first time interval corresponds to the beginning of the second time interval. The end of the second time interval corresponds to the beginning of the third time interval.

At 552, the intake port 150 is opened at the beginning of the first time interval. At 554, fuel and compressed gas are received into the combustion chamber during first time interval. At 556, the intake port 150 is closed at the end of the first time interval. The intake port is opened by instruction of the control unit.

At 558, combustion is started within the second time interval, for example right after the closing of the intake port 150. Combustion may be controllably started by igniting the ignitor unit 154.

At 560, pressure builds up such that the pressure difference between the inside of the combustion chamber 102 and the target of the combusted gas (the turbine or a pressure tank between the combustion chamber 102 and the turbine) is above a predetermined level. When the predetermined level is reached, the combusted gas is ejected from the first discharge port 152 during part of the second time interval. The second discharge ports closes at any time during the second time period, when the difference falls under the threshold. When the first discharge port closes, combustion remnants remain in the combustion chamber.

At 562 the second discharge port 156 is opened at the beginning of the third time interval to empty the combustion chamber 102 in preparation for the new cycle. In the third time interval, the combustion remnants may be drawn from the combustion chamber 102 by the compressor, for recycling and reintroduction into the combustion chamber at a later cycle. The second discharge port 156 port is opened by instruction of the control unit. At 564, the second discharge port 156 is closed at the end of the third interval. The second discharge port 156 port is closed by instruction of the control unit. Once the combustion cycle ends, a new cycle may begin, by looping back to step 552.

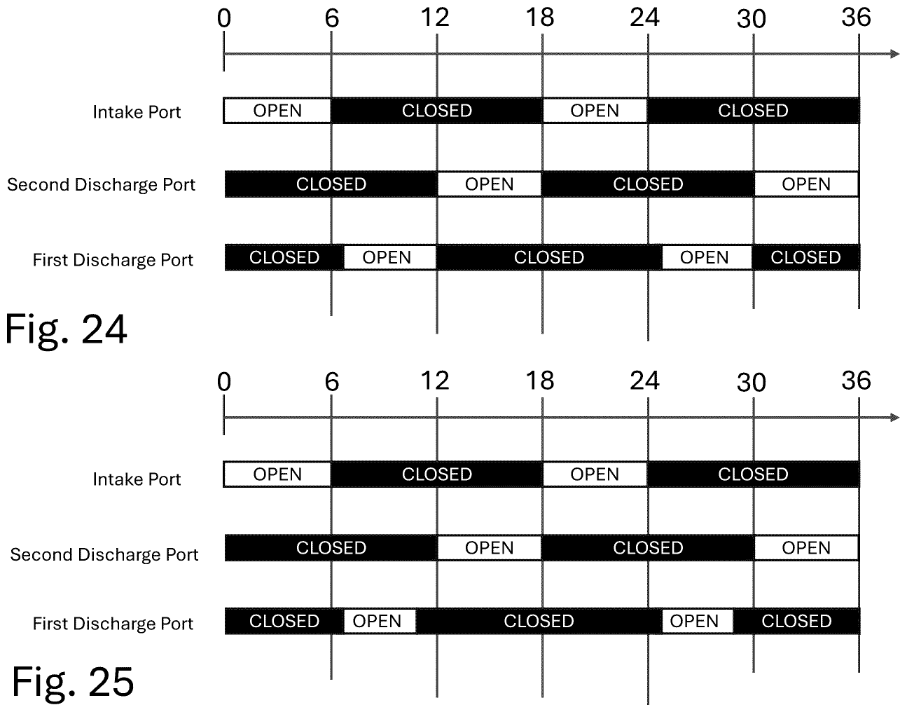

FIGS. 24 and 25 illustrate examples of the two consecutive 18-second combustion cycles. The first time interval starts at 0 seconds and ends at 6 seconds. The intake port opens at 0.01 seconds to receive compressed gas and fuel, and closes at 6 seconds.

The second time interval starts at 6 seconds and ends at 12 seconds. Combustion starts right after the closing of the intake port, for example at 6.01 seconds. Following the beginning of the combustion, the pressure in the combustion chamber builds up and the pressure difference between the inside of the combustion chamber 102 and the target of the combusted gas reaches a predetermined level in the second time interval, for example at 6.5 seconds. The first discharge port opens at 6.5 seconds.

When the pressure difference falls below the predetermined level, the first discharge port closes. This may happen at any time in the second time interval (after the opening of the first discharge port), depending on the pressure difference over time. In the example of FIG. 24, the second discharge port closes at 12 seconds. In the example of FIG. 25, the second discharge port closes at 11 seconds.

The third time interval starts at 12 seconds and ends at 18 seconds. The second discharge port opens any time during the third time interval, for example at 12.01 seconds, and closes at any time during the third time interval (after the opening of the second discharge port), for example at 18 seconds. The next combustion period starts at 18 seconds and ends at 36 seconds.

It should be noted that the above mentioned times are only examples, and differently-timed cycles and time intervals may be used and are within the scope of the present invention.

In a non-limiting, the system includes twelve combustion chambers. The combustion cycles of the combustion chambers are sequential and the delay between two consecutive cycles is 1.5 seconds. In this manner, the combustion cycle of the first combustion chamber 102 ends 1.5 seconds after the combustion cycle of the last combustion chamber 124 begins. In this manner a constant flow of combusted gas is provided, even though the combustion cycles are discrete combustion cycles and not continuous.

The number of combustion chambers with sequential cycles, and the delays between consecutive cycles may be chosen according the system's design and requirements. Different numbers of combustion chambers, different durations of combustion cycles and of first, second, and third time intervals, and different delays between consecutive cycles are within the scope of the present invention.

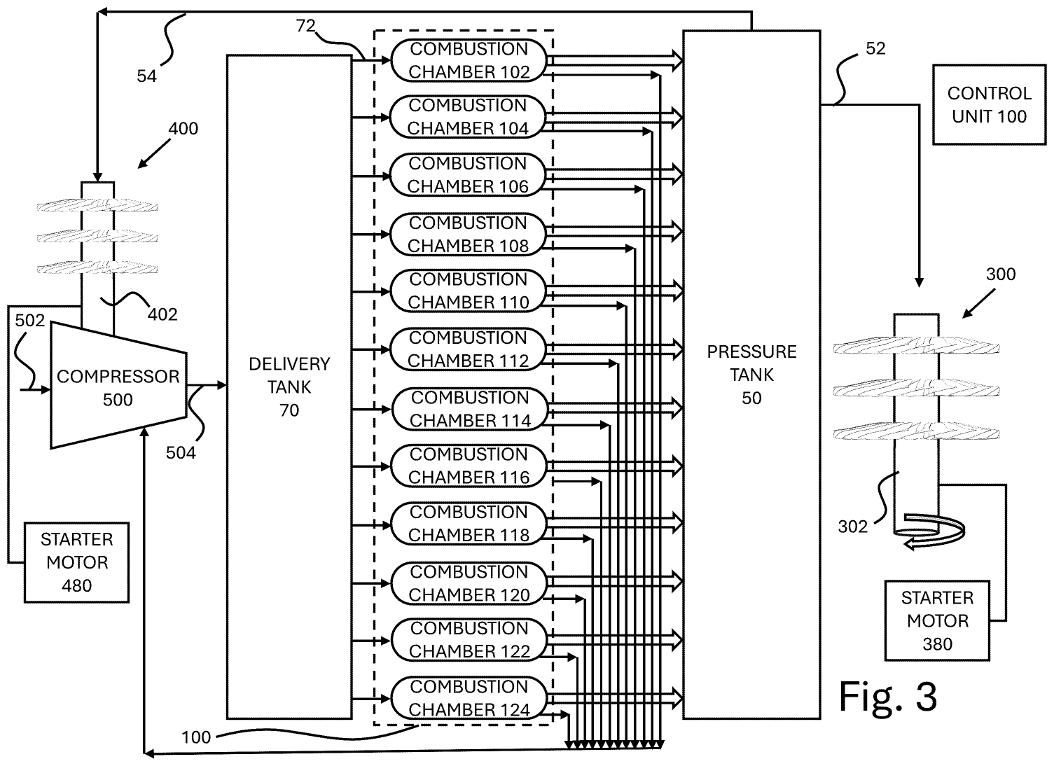

FIG. 3 illustrates a gas turbine system which includes a pressure tank 50 for receiving combusted gas and delivering the combusted gas to a turbine apparatus 300, according to some embodiments of the present invention.

The gas turbine system includes a combustor apparatus 100 and a pressure tank 50. The combustor apparatus 100 includes one or more combustion chambers (102-124), as described above. The one or more combustion chambers (102-124) receive compressed gas and a combustion fuel, and generate combustion of the compressed gas. The combustion generates combusted gas. Each of the combustion chambers includes at least one discharge port for discharging the combusted gas out of the combustion chamber. The pressure tank 50 includes one or more inlets coupled to the discharge ports of the combustion chambers for receiving the combusted gas released from the combustion chamber(s). The pressure tank 50 stores the combusted gas at high pressure (for example at 500 psi, 1000 psi or higher), and has one or more first outlets 52 to deliver the combusted gas to one or more turbine apparatuses (300, 400) via one or more first outlets for rotating the one or more turbines. The rotation of the turbine(s) is converted to electrical energy according to well-known techniques. The turbines may be vertical, horizontal, or somewhere in between.

The presence of the pressure tank 50 is a departure from conventional gas turbine power plants, in which the combusted gas from the combustion apparatus is released directly to the turbines right after combustion occurs. The presence of the pressure tank 50 allows for controllable release of the combusted gas to the appropriate turbine apparatuses (300, 400). As will be seen later, the pressure tank 50 may release the combusted gas into eductors placed at strategic locations relative to the turbine to more efficiently direct the combusted gas to rotate the turbine. A more efficient delivery of the combusted gas to the turbine enhances the energy output from the turbine, and therefore enables use of less fuel for the same output of electrical energy. According to calculations run by the inventor, when natural gas is used as a fuel, the increased efficiency leads to the decreased use of fuel by up to 80%, and the production of CO₂ by about 50%.

Moreover, the efficient delivery of the combusted gas to the turbine enables combustion which produces combusted gas with a lower temperature and lower pressure than those of gas combusted in conventional gas turbine power plants. In fact, in conventional gas turbine power plants, the combusted gas expands significantly before reaching the turbine, losing much pressure. In contrast, in the present invention, the pressure of the combusted gas is maintained in the pressure tank 50 and can be delivered to the turbine via gas lines which maintain the pressure and release the gas in close proximity to the turbine, such that expansion and pressure loss occur on a much more limited scale before the compressed gas is utilized to rotate the turbine. A lower pressure of the combusted gas in the combustion chamber(s) is linked to a lower combustion temperature, which decreases the production of NOx. According to calculations run by the inventor, when natural gas is used as a fuel, the combustion temperature can even be lowered to below 600° C., producing a concentration of NOx to 2 ppm or less in the emitted gas.

Moreover, the presence of the pressure tank 50 enables the gas turbine system of the present invention to be configured in discrete components (compressor, combustion apparatus, and turbine) that are not integral with each other. This enables the different elements of the gas turbine system to be placed away from each other and configured to conform to the available space. In contrast, in conventional gas turbine power plants, the compressor, combustor, and turbine are integrated in a single structure that cannot be configured according to the user's needs and space requirements. Moreover, the discrete components may be more easily maintained and replaced when not in close proximity to one another.

Generally, the gas is compressed via a compressor 500, which has an inlet 502 and an outlet 504. The compressor 500 receives gas (e.g., ambient air) and compresses the gas. The compressed gas exits the compressor 500 via the outlet 504 and is delivered, along with fuel, to the combustor apparatus 100 for the combustion to occur.

The compressor may be powered by a turbine apparatus 400. In some embodiments of the present invention, the turbine apparatus 400 is rotated by combusted gas from the pressure tank 50. It is understood that when the system first starts, the compressor 500 is initially powered by different means (e.g., a starter motor 480, as will be explained below), and only when combusted gas becomes available at a desired pressure, the combusted gas is delivered to the turbine apparatus 400 from the pressure tank 50 to continue powering the compressor 500.

The compressed gas may be delivered directly to the combustor apparatus 100 or may be delivered to a delivery tank 70. The delivery tank 70 includes an inlet coupled to the outlet of the compressor 500 to receive compressed air from the compressor 500. The delivery tank 70 stores the compressed air at a desired pressure and delivers the compressed air to the combustion chamber(s) (102-124) via one or more egress channels 72. The presence of the delivery tank 70 may make it easier for the compressed gas to be delivered to a plurality of combustion chambers (102-124), either simultaneously or successively, with minimal or no loss of pressure during the delivery. The delivery of the compressed gas from the delivery tank 70 to the one or more combustion chambers may be effected via respective first eductors, as shown in FIG. 8 and explained above.

In some embodiments of the present invention, combustion remnants, that may include some fuel and some uncombusted or partially combusted gas, are led from the combustion chamber(s) (102-124) back to the compressor 500, and back into the combustion chamber(s) in order to complete the combustion. This enables the combustion remnants to go through another combustion cycle and decreases emission of incomplete combustion products, such as CO.

In some embodiments of the present invention, the turbine apparatuses (300, 400) are associated with respective starter motors (380, 480). The starter motor spins the rod (302, 402) of the respective turbine apparatus until a predetermined rotation speed is reached. Then the starter motor is disconnected from the rod and the combusted gas is ejected toward the turbine(s) to keep the turbine(s) and rod rotating. In this manner, the combusted gas is not wasted to start the rotation of the turbines. This may further increase the fuel efficiency of the system of the present invention. The operation of the starter motor(s) may be controlled by the control unit

In some embodiments of the present invention, the combustor apparatus 100 includes a plurality of combustion chambers 102-124, and combustion occurs in at least some of the combustion chambers 102-124 sequentially. In this manner combusted gas can be provided to the pressure tank continuously, even through discrete combustion cycles, and a desired pressure within the pressure tank is maintained.

A control unit 100 may be included in the system of the present invention, to control the operation of the different components and the passage of fluid therebetween. The control unit may control the opening of the intake and discharge ports of the combustion chamber(s), the ignition of ignitor units (such as spark plugs, for example) of the combustion chambers (if present), the operation of the starter motors (if present), delivery of combusted gas from the pressure tank to the turbine(s), and the delivery of the combusted gas to individual eductors or groups of eductors aimed at the turbines.

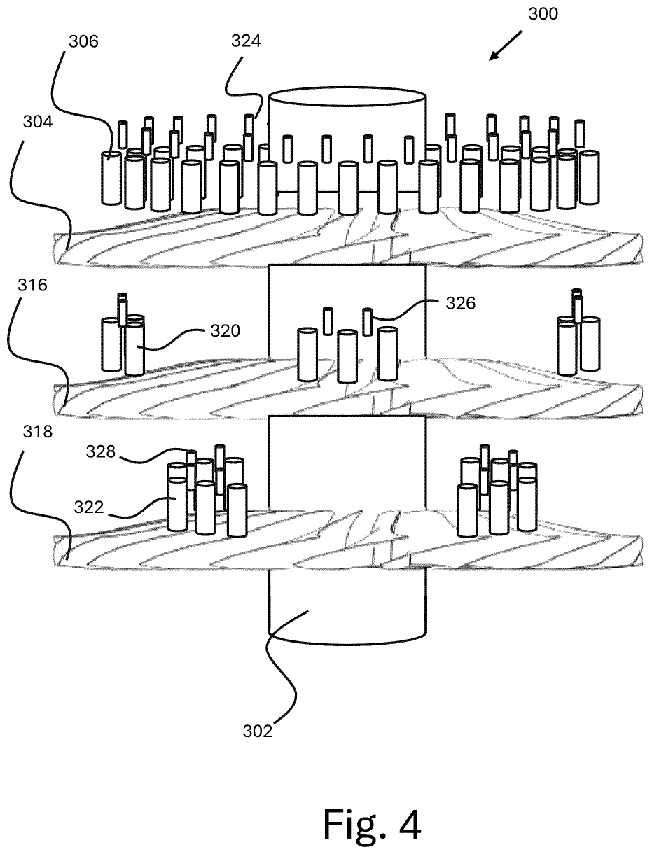

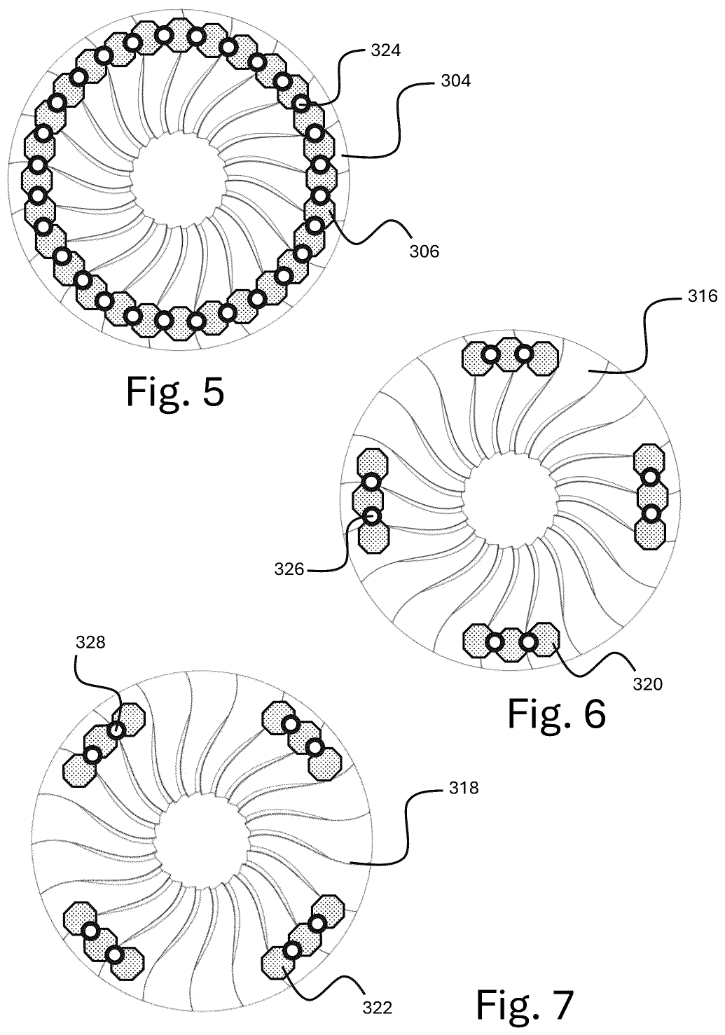

FIG. 4 illustrates a gas turbine including one or more turbines receiving pressurized gas via eductors, according to some embodiments of the present invention. FIGS. 4-6 are top views of a top, middle, and low turbine, respectively, showing examples of locations of eductors above the respective turbines, according to some embodiments of the present invention.

An aspect of some embodiments of the present invention relates to a gas turbine apparatus that receives pressurized gas, independently of how the pressurized gas is produced. Though the system which includes the compressor and combustion apparatus described above provides many advantages, the gas turbine apparatus that will be described below is advantageous in its own right too. The turbine apparatus may be part of the gas turbine system described above, or may be used by provision of pressurized gas in a different manner.

The gas turbine apparatus 300 includes a shaft 302 and at least one turbine 304, and at least one eductor 306. The source of pressurized gas may be a combustion chamber or a pressure tank, as explained above, though other sources of pressurized gas may be conceivable. The source of pressurized gas is connected to the eductor 306 and provides the pressurized gas to the eductor. The eductor is placed at a location relative the turbine 304, in order to direct the pressurized gas to the turbine in an effective and advantageous manner, in order to cause the turbine to rotate. This is a departure from gas turbines in conventional gas turbines power plants where the gas pressurized from a combustion process travels to the turbine directly from the combustion apparatus and expands significantly before reaching the turbine.

In the present invention, the pressurized gas is led to the eductors(s) 306 via gas lines that decrease or prevent expansion, and is released by the eductor(s) near the blades of the turbine with little to no loss of pressure. It should be noted that though the turbine apparatus 300 in FIG. 4 is as vertical turbine, the turbine apparatus 300 may be a horizontal turbine.

As seen in FIG. 9, the eductor 306 has a gas entry opening 310 for receiving the pressurized gas form a gas line and an exit opening 312 for releasing the pressurized gas in the vicinity of the turbine's blades, at an appropriate angle which takes advantage of the blades' structure and imparts torque to the blades efficiently.

In some embodiments of the present invention, the eductor also includes a liquid entry opening 314. The liquid and pressurized gas are released by the exit opening. The internal structure of the eductor 306 may be similar to the internal structure of the eductor 180 of FIG. 7b, described above. The pressurized/combusted gas is the motive fluid, drawing the liquid into the liquid entry opening 314 and leading the liquid with the pressurized/combusted gas out of the exit opening 312. The liquid may be, for example, water or any other economically suitable liquid. In some embodiments of the present invention, the liquid may be mixed with any other additive/s to minimize corrosion, mineral buildup, foaming or to increase its boiling point.

The addition of liquid to the pressurized gas is advantageous because the liquid can cool down a hot gas. The cooling of the gas may decrease the chance of NOx formation and the may increase the durability of the turbine's blades. Moreover, the impact of the liquid onto the turbine blades may be more effective than gas in producing torque.

In some embodiments of the present invention, the turbine apparatus includes a plurality of vertical turbines disposed vertically one above the other. For example, in the turbine apparatus 300, an upper turbine 304, a middle turbine 316, and a lower turbine 318 are present, all joined to the same shaft 302 and rotating with the shaft 302. The eductors are grouped in plurality of sets. Each set of eductors includes one or more eductors aimed at a respective one of the vertical turbines. For example, the eductors 306 are aimed at the upper turbine 304, the eductors 320 are aimed at the middle turbine 316, while the eductors 322 are aimed at the bottom turbine 318.

In some embodiments of the present invention the eductors of at least two consecutive sets associated with the two consecutive turbines are disposed in a staggered manner. In this the eductors of one of the two consecutive sets are not vertically aligned with the eductors of another one of the two consecutive sets.

For example, the eductors 320 aimed at the middle turbine 316 are not vertically aligned with the eductors 322 aimed at the lower turbine 318. In this manner, gas (and optionally liquid) emitted by the eductors 320 pass through the middle turbine 316 and impart torque thereto, and are more likely to land on sections of the lower turbine 318 that are not impacted by gas (and optionally liquid) emitted by the eductors 322. In this manner the turbines can use gas (and optionally liquid) not directly aimed thereto to increase torque.

In some embodiments of the present invention, one or more liquid jet nozzles are located near at least one of the eductors and configured to emit liquid jets to the respective turbine. This helps cool down the turbine blades and is particularly important when hot gas is aimed toward the turbine blades. In the example of FIGS. 4-7, the liquid jet nozzles 324 are aimed at the upper turbine 304, the liquid jet nozzles 326 are aimed at the middle turbine 316, and the liquid jet nozzles 328 are aimed at the lower turbine 318.

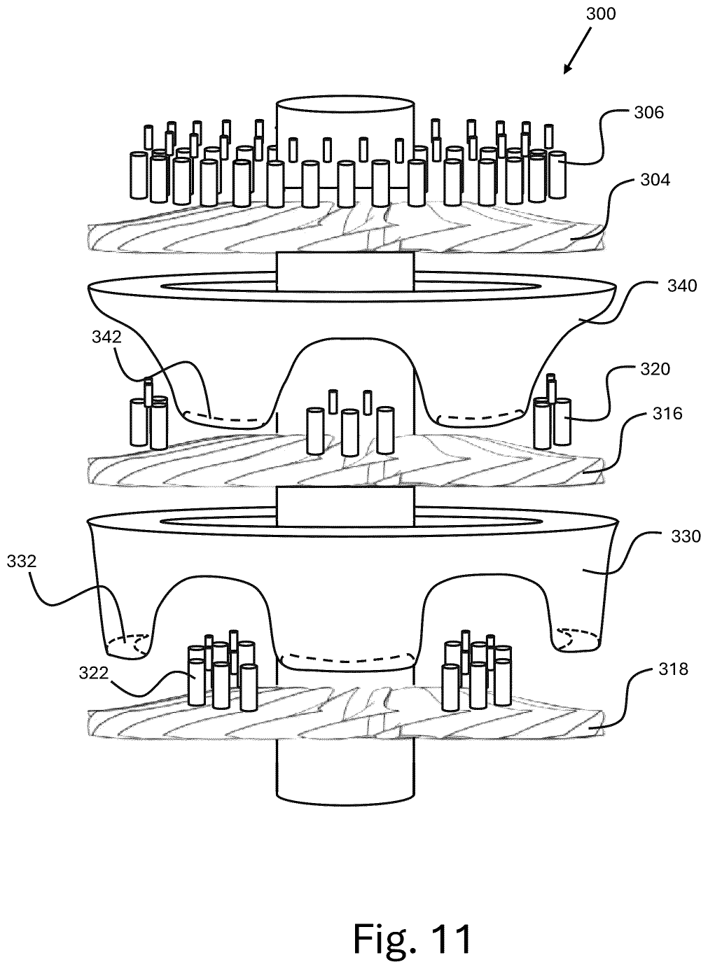

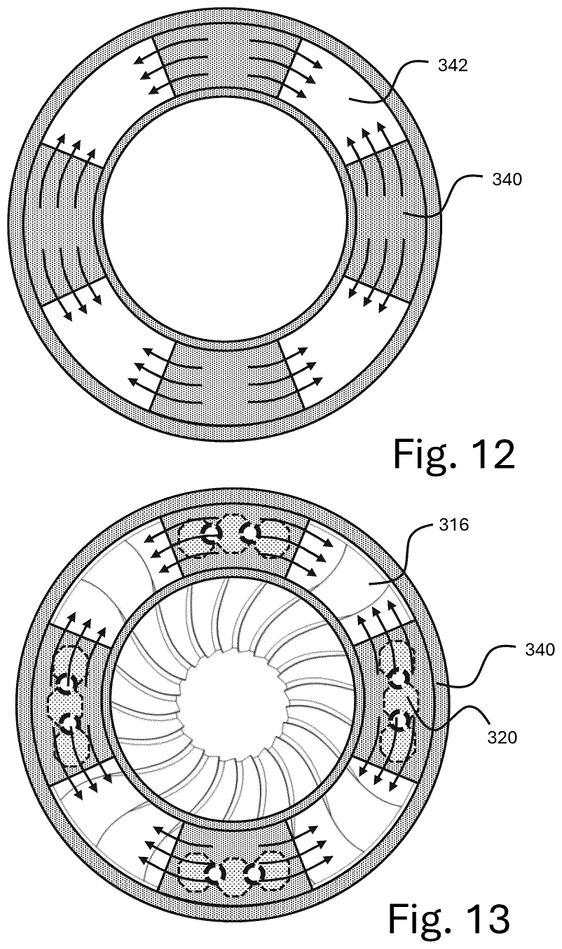

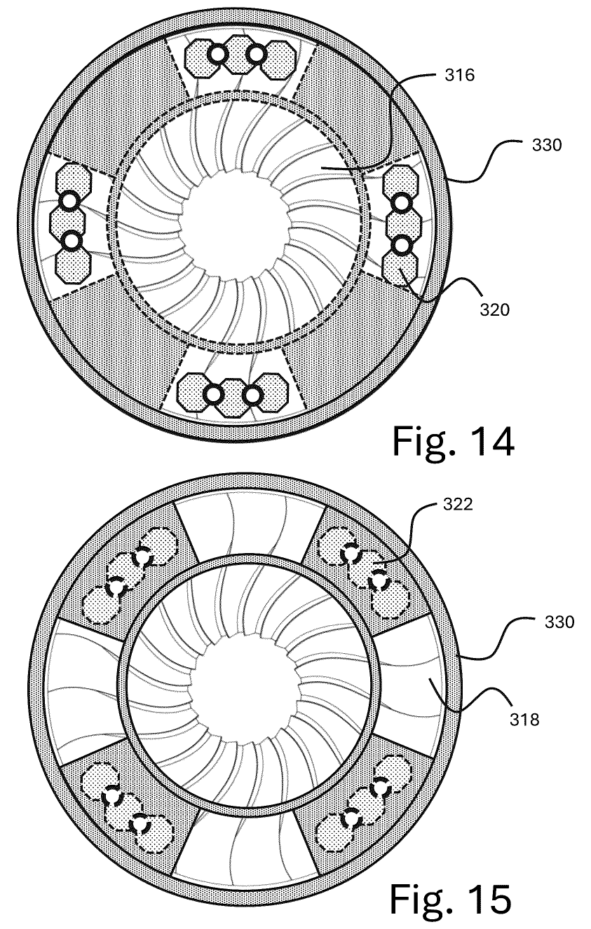

FIG. 11 illustrates a multi-turbine system in which a plurality of turbines are located above each other, and pressurized gas is directed from upper turbines to lower turbines via a ducting structure, according to some embodiments of the present invention. FIG. 12 illustrates a top view of the ducting structure, according to some embodiments, of the present invention. FIG. 13 illustrates a top view of the ducting structure above the middle turbine, according to some embodiments, of the present invention. FIG. 14 illustrates a top view of a second ducting structure below the middle turbine, according to some embodiments, of the present invention. FIG. 15 illustrates a top view of the second ducting structure above the lower turbine, according to some embodiments, of the present invention.

In some embodiments of the present invention, the turbine apparatus 300 includes at least one ducting structure 330 located between consecutive turbines. The ducting structure has openings 332 aligned with locations of a lower one of the two consecutive turbines that are not impacted by pressurized gas from eductors of a set associated with the lower one of the two consecutive turbines.

For example, a ducting structure 330 is located between the middle turbine 316 and the lower turbine 318. The ducting structure 330 captures pressurized gas (and optionally liquid) emitted by the eductors 320 that has gone through the middle turbine 316 and imparted torque to the middle turbine 316. The captured pressurized gas (and optionally liquid) are directed via channels having openings 332 toward the locations of the lower turbine 318 that are not impacted by pressurized gas (and optionally liquid) emitted by the eductors 322. Optionally, a ducting structure 340 is located between the upper turbine 304 and the middle turbine 316. The ducting structure 340 captures pressurized gas (and optionally liquid) emitted by the eductors 306 that has gone through the upper turbine 306 and imparted torque to the upper turbine 306. The captured pressurized gas (and optionally liquid) are directed via channels having openings 342 toward the location of the middle turbine 316 that are not impacted by pressurized gas (and optionally liquid) emitted by the eductors 320.

In this manner, pressurized gas (and optionally liquid) emitted from eductors aimed at higher turbines are driven by gravity and redirected to impact regions of the lower turbines that would otherwise not be impacted by pressurized gas (and optionally liquid). This increases the torque imparted to the turbine apparatus.

In FIG. 13, the eductors 320 and jets above the middle turbine 316 are illustrated in dotted lines, to show that these elements are located under the ducting structure 340 (but not aligned with the openings 342 of the ducting structure 340). In FIG. 14, the portion of the ducting structure 330 that is under the middle turbine 316 is shown as partially transparent and in dotted lines to show that the ducting structure 330 is under the middle turbine 316. In FIG. 15, the eductors 322 and jets above the lower turbine 318 are illustrated in dotted lines, to show that these elements are located under the ducting structure 330 (but not aligned with the openings of the ducting structure 330).

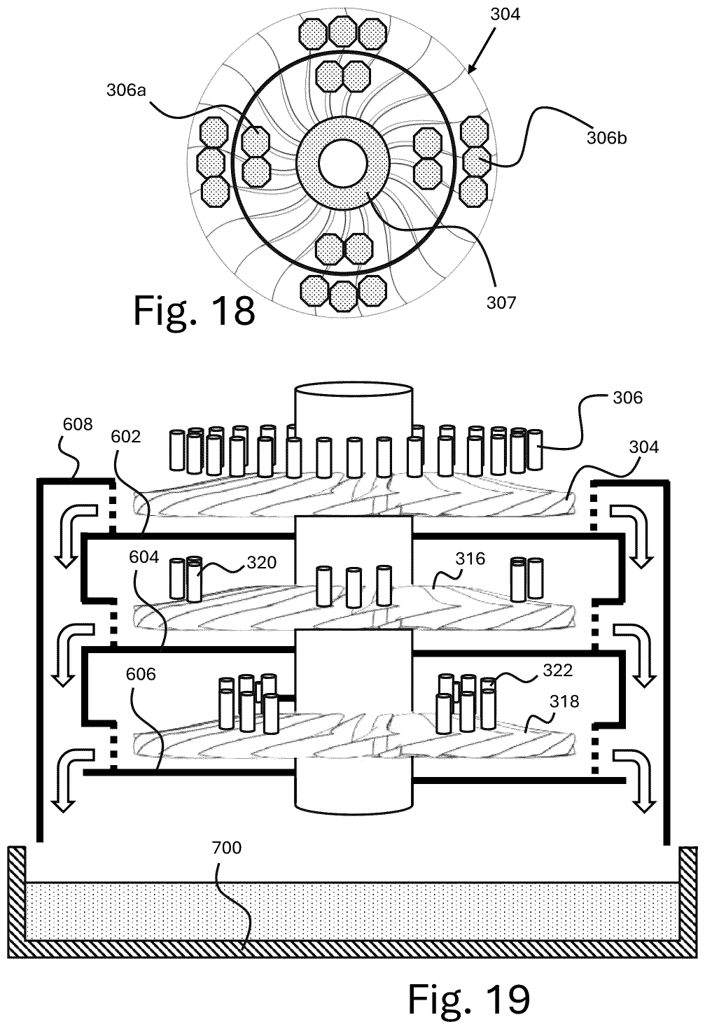

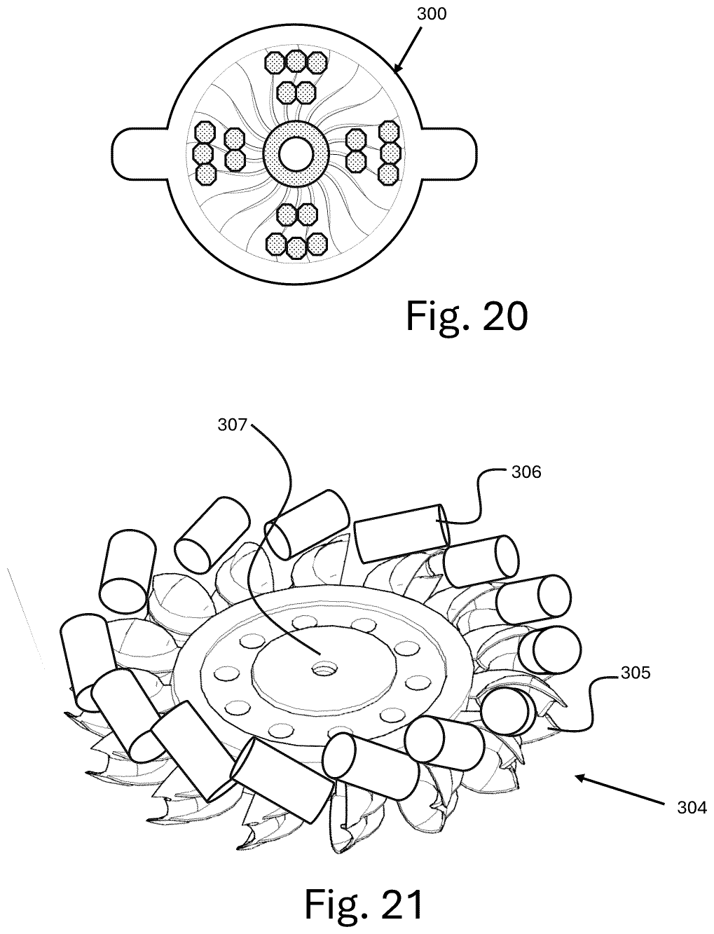

FIGS. 19 and 20 illustrate a turbine apparatus which include a gutter structure, according to some embodiments, of the present invention.

In some embodiments of the present invention, the turbine apparatus 300 includes a gutter structure 600 which includes a plurality of receptacles (602, 604, 606) and spout 608.

Each receptacle is located under a respective turbine and configured to collect the liquid that was released toward the respective turbine after the liquid has interacted with the respective turbine. For example, an upper receptacle 602 is located under the upper turbine 304, but above the middle turbine 316. The upper receptacle captures the liquid that was emitted toward the upper turbine 304 by the eductors 306. Similarly, a middle receptacle 604 is located under the middle turbine 316, but above the lower turbine 318. The middle receptacle captures the liquid that was emitted toward the middle turbine 316 by the eductors 320. Finally, a lower receptacle 606 is located under the lower turbine 318. The lower receptacle captures the liquid that was emitted toward the lower turbine 318 by the eductors 322. The spout 608 is in communication with the receptacles (602, 604, 606), and is configured to receive the liquid from the receptacles and to lead the liquid to a sump 700.

In this manner, liquid is recovered from system and can be reused (as will be explained further below).

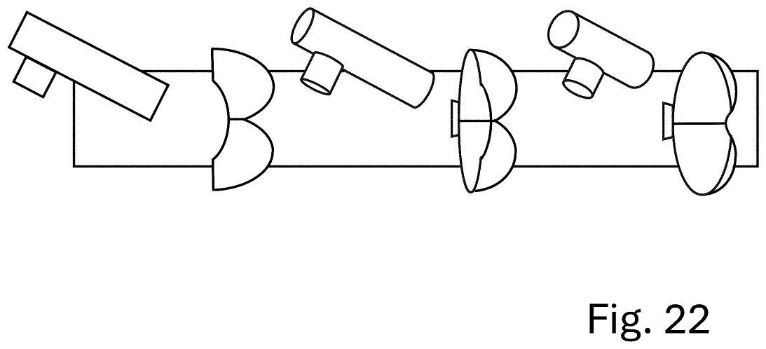

FIGS. 21 and 22 illustrate a turbine with Pelton blades, according to some embodiments, of the present invention.

In the examples shown above, the eductor(s) is (are) oriented vertically. This configuration works for airfoil-shaped blades, Kaplan blades, and Francis blades.

In some embodiments of the present invention, the turbine 304 is a Pelton-type turbine with Pelton blades 305 extending radially outward from a circumference of the turbine's hub 307. In these embodiments, the one or more eductors 306 are not oriented vertically, but substantially horizontally (for example, between +15 degrees and −15 degrees) or diagonally, in order to effectively impact the Pelton blades 305.

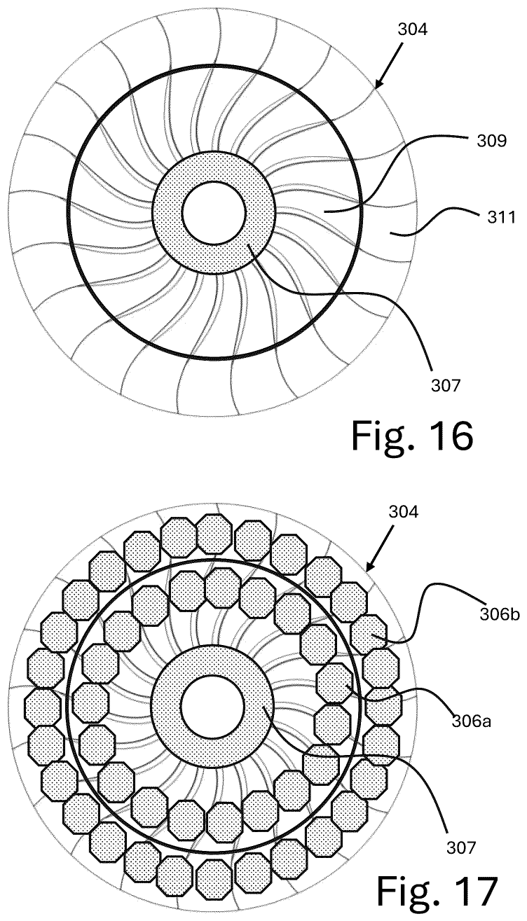

FIGS. 16-18 illustrate a turbine 304 with extended turbine blades for receiving air from two groups of eductors forming an inner group and an outer group,

The eductors may be divided into inner eductors 306a and outer eductors 306b. The inner eductors 306a extend circumferentially closer to the hub 307 than the outer eductors 306b. The inner eductors 306a and the outer eductors 306b may be controlled independently, such that a user can select whether only the inner eductors 306a emit pressurized gas (and optionally, liquid), only the outer eductors 306b emit pressurized gas (and optionally, liquid), or both the inner eductors 306a and the outer eductors 306b emit pressurized gas (and optionally, liquid). The user can make these choices based on energy demand at any given time. At peak hours, when energy demand is high, the inner and outer eductors may be activated to provide higher torque, but more fuel is needed. When energy demand is low, only the inner eductors or outer eductors are activated, thereby providing the necessary energy while saving fuels. In some embodiments of the present invention, individual eductors may be activated independently from each other. The activation of the eductors may be controlled via the control unit.

This feature allows the adjustment of operation of a gas turbine power plant to account for various levels of energy demand, while being efficient in the use of fuel.

In some embodiment of the present invention, the turbine 304 has a core shape with blades 309 extending from the hub 307 and an extended shape with blade extensions 311 joined to the blades 309 and extending outwards. The blade extension can be mounted on the blades 309 in order to receive gas (and optionally liquid) when energy demand is high. This feature allows to save fuel when energy demand is low, as the weight of the turbine in its core shape is lower than the weight of the turbine in its extended shape. Removal of the extensions 311 when energy demand is low allows the inner eductors 306a to more efficiently rotate the turbine 304.

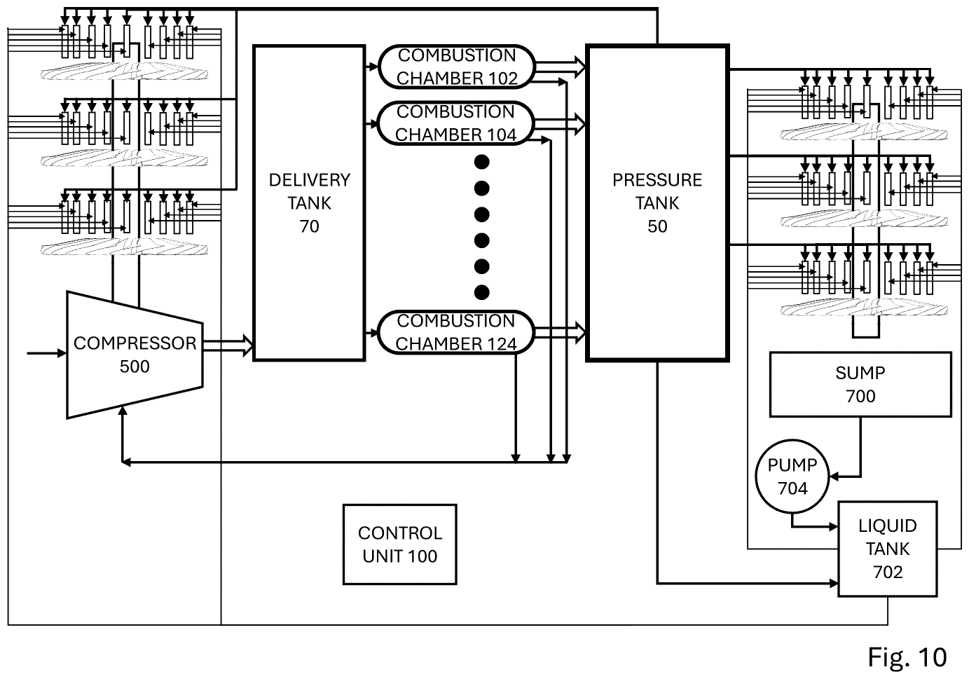

FIG. 10 illustrates gas turbine system using liquid and combusted/gas to propel turbines, according to some embodiments of the present invention.

The system of FIG. 10 is similar to the system of FIG. 1 or 3. In addition to the features of FIG. 1 or 3, the system of FIG. 9 also provides liquid to the eductors aimed at the turbines. The liquid is collected in a sump 700 and pumped to a liquid tank 702 by a pump 704. The liquid in the liquid tank 702 is the reused and provided again to the eductors aimed at the turbines. In some embodiments of the present invention, combusted gas from the pressure tank is used to pressurize the liquid in the liquid tank 702 and lead the liquid in the liquid tank back to the eductors. The pump may be controlled by the control unit 100.

The reuse of liquid saves costs, as it creates a closed or partially closed liquid loop with decreased need to add more liquid. Moreover, the use of combusted gas from the pressure tank to lead the recovered liquid back to the eductors utilizes a plentiful, readily available resource that is already provided by the combustion process, in order to operate the system.

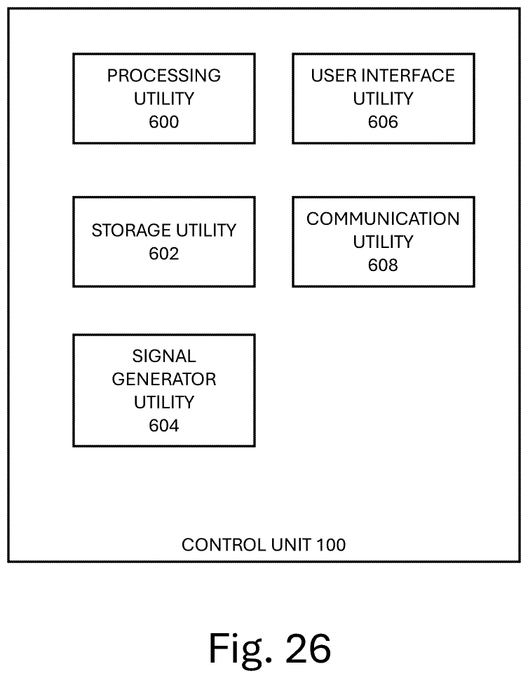

FIG. 26 is a block diagram of the control unit 100. As mentioned above, the control unit 100 controls the operations of the different components of the gas turbine system.

The control unit 100 includes a processing utility 600, a storage utility 602, a signal generator utility 604, and optionally a user interface utility 606. Each of the utility includes software and/or hardware components to enable the utilities to perform their functions.

The storage utility 602 is a non-volatile memory utility configured to store machine readable instructions. The processing unit is configured to process the machine readable instructions and instruct the signal generator 604 to generate control signals at desired times. The control signal are sent to the components of the gas turbine system to control the timing and operation of these components, as described above.

In some embodiments of the present invention, the user interface utility 606 enables a user to change the machine readable instruction, to input new machine readable instruction, in order to control the operation of the gas turbine system. In some embodiments of the present invention, the user interface utility 606 is configured to display information to the user, the information being related to the operation of different components of the gas turbine system.

In some embodiments of the present invention a plurality of sensors 700 (e.g., pressure, temperature sensors) are placed at different locations in the gas turbine system to measure conditions at the different locations. In some embodiments of the present invention, a communication utility 608 is included in the control unit 100 to receive the measurements from the sensors 700. The sensors measurements may be displayed by the user interface utility 606, and may be used by the processing unit utility 600 to control instruct the signal generator to generate the signal generator utility, based on the conditions at the different locations in the gas turbine system.

Although the invention is described above in terms of various exemplary embodiments and implementations, it should be understood that the various features, aspects, time measurements, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

1. A gas turbine system, comprising:
a combustor apparatus comprising at least one combustion chamber configured to receive compressed gas and a combustion fuel, configured to generate combustion of the compressed gas thereby generating combusted gas, and configured to release the combusted gas;
a pressure tank, configured to receive the combusted gas released from the at least one combustion chamber, store the combusted gas at a desired pressure, and controllably deliver the combusted gas to one or more turbines via one or more first outlets, for rotating the one or more turbines.

2. The gas turbine system of claim 1, wherein the combustor apparatus comprises a plurality of combustion chambers, each of the combustion chambers being configured to receive the compressed gas and the combustion fuel separately, to generate a respective combustion of the compressed gas, and to release the combusted gas to the pressure tank.

3. The gas turbine system of claim 2, wherein the combustion chambers are configured to receive the gas and the fuel at successive time intervals such that the combustion occurs sequentially in at least some of the combustion chambers, and to sequentially release the combusted gas.

4. The gas turbine system of claim 3, comprising a plurality of ignitor units, wherein:
each of the combustion chambers comprises a respective one of the ignitor units;
at least some of the ignitor units are controlled to sequentially ignite respective sparks, to cause the combustion to occur sequentially in the at least some of the combustion chambers.

5. The gas turbine system of claim 1, wherein the at least one combustor chamber comprises:
an intake port configured to be controlled to open for receiving the gas and the fuel during a first time interval and close at the end of the first time interval;
a first discharge port configured to open at a time after the first time interval, when a pressure inside the combustion chamber builds up to a predetermined pressure as a result of the combustion and to close when the pressure inside the combustion chamber falls below the predetermined pressure, wherein the first discharge port is in communication with the pressure tank and is configured to discharge the combusted gas to the pressure tank, when open.

6. The gas turbine system of claim 1, wherein for the at least one combustor chamber, a combustion cycle occurs during a cycle period divided into a first time interval, a second time interval, and a third time interval, and wherein the at least one combustion chamber comprises:
an intake port configured to be controlled to open for receiving the gas and the fuel during at the beginning of the first time interval and to close at the end of the first time interval;
a first discharge port configured to open during the second time interval when a pressure inside the combustion chamber builds up to a predetermined pressure as a result of the combustion, to discharge the combusted gas, and to close when the pressure inside the combustion chamber falls below the predetermined pressure, wherein the first discharge port is in communication with the pressure tank and is configured to discharge the combusted gas to the pressure tank, when open;
a second discharge port configured to be controlled to open at the beginning of the third time interval, to discharge combustion remnants, and to close at the end of the third time interval.

7. The gas turbine system of claim 6, further comprising a compressor for compressing gas and deliver the compressed gas to the at least one combustion chamber;
wherein the second discharge port is in communication with an inlet of the compressor and is configured to deliver the combustion remnants to the compressor for compression and delivery to the combustor apparatus.

8. The gas turbine system of claim 1, further comprising a compressor for compressing gas and deliver the compressed gas to the at least one combustion chamber, wherein:
the compressor comprises a second turbine configured to power the compressor,
the pressure tank has at least one second outlet configured to deliver some of the combusted gas to the second turbine for rotating the second turbine.

9. The gas turbine system of claim 1, comprising at least one eductor comprising a gas entry opening and an exit opening, wherein:
the gas entry opening is in communication with one of the one or more first outlets of the pressure tank and configured to receive the combusted gas therefrom;
the exit opening is directed toward blades of the one of more turbines, to release the combusted gas to the at least one turbine and cause the at least one turbine to rotate.

10. The gas turbine system of claim 9, wherein the at least one eductor comprises a liquid entry opening configured to receive liquid, such that a mixture of the compressed gas and the liquid is released from the exit opening to the at least one turbine.

11. The gas turbine system of claim 9, comprising a plurality of eductors having respective exit openings directed at respective locations of the at least one turbine.

12. The gas turbine system of claim 2, comprising a delivery tank configured to receive the compressed gas, the delivery tank having a plurality of egress channels, each of the egress channels configured to deliver the compressed gas to a respective one of the plurality of combustion chambers.

13. A gas turbine system, comprising:
a source of pressurized gas;
at least one eductor comprising a gas entry opening and an exit opening, wherein:
the gas entry opening is configured to receive the pressurized gas;
the exit opening is directed toward a turbine, to release the pressurized gas to the turbine in order to cause the turbine to rotate.

14. The gas turbine system of claim 13, wherein the at least one eductor comprises a liquid entry opening configured to receive a liquid, such that a mixture of the pressurized gas and the liquid is released from the exit opening to the turbine.

15. The gas turbine system of claim 13, comprising a plurality of eductors having respective exit openings directed at respective locations of the turbine.

16. The gas turbine system of claim 13, comprising at least one vertical turbine having at least one Pelton blade, wherein the at least one eductor is configured to release the pressurized gas to the turbine substantially horizontally to impact the at least one Pelton blade, in order to cause the turbine to rotate along a vertical axis.

17. A gas turbine system, comprising:
a plurality of vertical turbines, disposed vertically, and joined to a common central rod;
a plurality of sets of eductors, each set of eductors comprising one or more eductors aimed at a respective one of the vertical turbines;
wherein each of the eductors comprises a gas entry opening and an exit opening, wherein:
the gas entry opening is configured to receive pressurized gas from a pressurized gas source;
the exit opening is directed toward the respective one of the turbines, to release the pressurized gas to turbine in order to cause the respective one of the turbines to rotate.

18. The gas turbine system of claim 17, wherein at least one of the eductors comprises a liquid entry opening configured to receive a liquid, such that a mixture of the compressed gas and the liquid is released from the exit opening to the respective one of the turbines.

19. The gas turbine system of claim 17, comprising at least one liquid jet nozzle located near at least one of the eductors and configured to emit a liquid jet to the respective turbine.

20. The system of claim 19, comprising:
a sump located under a lowermost of the vertical turbine, the sump being configured to collect the liquid released from the exit opening of the at least one of the eductors which comprises the liquid entry opening;
a liquid line redirecting at least some of the liquid from the sump back into liquid entry opening of the at least one of the eductors.

21. The system of claim 20, comprising a gutter structure comprising:
a plurality of receptacles, each receptacle being located under a respective one of the turbines and configured to collect the liquid that was released toward the respective one of the turbines after the liquid has interacted with the respective one of the turbines;
a spout in communication with the receptacles, and configured to receive the liquid from the receptacle and to lead the liquid to a sump.

22. The system of claim 16, wherein:
the turbines are configured to turn along a vertical axis when the pressurized gas travels downwards through the turbines;
each set of eductors is coupled to a respective one of the turbines, comprises a plurality of eductors located above the respective one of the turbines, and is configured to eject the pressurized gas substantially vertically;
the eductors of at least two consecutive sets associated with the two consecutive turbines of the plurality of the turbines are disposed in a staggered manner, such that the eductors of one of the two consecutive sets are not vertically aligned with the eductors of another one of the two consecutive sets.

23. The system of claim 17, wherein:
the turbines are configured to turn along a vertical axis when the pressurized gas travels downwards through the turbines;
each set of eductors is coupled to a respective one of the turbines, comprises a plurality of eductors located above the respective one of the turbines, and is configured to eject the pressurized gas substantially vertically;
the system comprises a ducting structure between two consecutive turbines of the plurality of turbines, the ducting structure having openings aligned with locations of a lower one of the two consecutive turbines that are not impacted by pressurized gas from eductors of a set associated with the lower one of the two consecutive turbines.

24. A gas turbine system, comprising:
a combustor apparatus comprising at least one combustion chamber configured to receive compressed gas and a combustion fuel, configured to generate combustion of the compressed gas thereby generating combusted gas, and configured to release the combusted gas toward a turbine for rotating the turbine, wherein the at least one combustion chamber is configured to have a plurality of discrete sequential combustion cycles, each combustion cycle having an initial time interval in which the compressed gas and the combustion fuel are received, and a final time interval in which the combustion is performed and the combusted gas is released toward the turbine, the initial and final time interval being sequential to one another.

25. The gas turbine system of claim 24, further comprising:
a control unit configured to control a timing sequence of operations of the at least one combustion chamber.

26. The gas turbine system of claim 24, wherein the combustor apparatus comprises a plurality of combustion chambers, each of the combustion chambers being configured to receive the compressed gas and the combustion fuel separately, to generate a respective combustion of the compressed gas, and to separately release the combusted gas.

27. The gas turbine system of claim 24, wherein the combustion chambers are configured to receive the gas and the fuel at successive time intervals such that the combustion occurs sequentially in at least some of the combustion chambers, and to sequentially release the combusted gas.

28. The gas turbine system of claim 27, comprising:
a plurality of ignitor units;
a control unit configured to control a timing sequence of operations of the at least one combustion chamber;
wherein:
each of the combustion chambers comprises a respective one of the ignitor units;
the control unit is configured to control at least some of the ignitor units to sequentially ignite respective sparks, to cause the combustions to occur sequentially in the at least some of the combustion chambers.

29. The gas turbine system of claim 24, wherein the at least one combustor chamber comprises:
an intake port configured to be controlled to open for receiving the gas and the fuel during the initial time interval and close at the end of the initial time interval;
a first discharge port configured to open at a time in the final time interval, when a pressure inside the combustion chamber builds up to a predetermined pressure as a result of the combustion and to close when the pressure inside the combustion chamber falls below the predetermined pressure, wherein the first discharge port is is configured to discharge the combusted gas out go the at least one combustor chamber, when open.

30. The gas turbine system of claim 24, wherein for the at least one combustor chamber, a combustion cycle occurs during a cycle period divided into a first time interval, a second time interval, and a third time interval, wherein the first time interval corresponds to the initial time interval, while the final time interval comprises the second time interval and the third time interval, and wherein the at least one combustion chamber comprises:
an intake port configured to be controlled to open for receiving the gas and the fuel during at the beginning of the first time interval and to close at the end of the first time interval;
a first discharge port configured to open during the second time interval when a pressure inside the combustion chamber builds up to a predetermined pressure as a result of the combustion, to discharge the combusted gas, and to close when the pressure inside the combustion chamber falls below the predetermined pressure, wherein the first discharge port is configured to discharge the combusted gas out go the at least one combustor chamber, when open;
a second discharge port configured to be controlled to open at the beginning of the third time interval, to discharge combustion remnants, and to close at the end of the third time interval.

31. The gas turbine system of claim 24, comprising a compressor configured to provide the compressed gas to the combustion apparatus, wherein the compressor is not physically integral with the combustion apparatus.

32. The gas turbine system of claim 24, comprising the turbine, wherein the combustor apparatus and the turbine are not physically integral with each other.

33. The gas turbine system of claim 25, wherein:
the control unit is configured as a computerized unit having a processing utility, and a storage utility;
the storage utility is configured to store machine readable instructions configured to cause the processing utility to generate control signals configured to be received by the combustor apparatus to control an operation of the control apparatus.
